(19) United States
(12) Patent Application Publication
(10) Pub. No.: US 2005/0222920 A1
(43) Pub. Date: Oct. 6, 2005

(54) Virtual shop system and method of controlling the same

(75) Inventors: Toyomi Yamagata, Osaka (JP); Tatsuo Koga, Osaka (JP); Akira Yoshimoto, Osaka (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/072,276

(22) Filed: Mar. 7, 2005

(30) Foreign Application Priority Data
Mar. 30, 2004 (JP) 2004-098155 (P)

(51) Int. Cl. G06F 17/60

(52) U.S. Cl. 705/27

(57) ABSTRACT

A customer operates a customer terminal to visit a virtual shop on the Internet. In the virtual shop a clerk operates a terminal having a monitor, which for example displays a period of time elapsing while pages of commodities a-d, respectively, are each browsed at customer terminals indicated by names for indication A, B, C, D.

### BACKGROUND OF THE INVENTION

1. Field of the Invention

The present invention relates generally to virtual shop systems and methods of controlling the same, and particularly to those transmitting information of a status of a terminal operated by a customer of a virtual shop to a terminal of a virtual shop to enable the shop's clerk(s) to better serve the customer.

2. Description of the Background Art

In recent years as information communications networks and equipment are increasingly developed and used, respectively, a variety of techniques are disclosed for commerce utilizing the Internet and other similar networks.

For example, Japanese Patent Laying-Open No. 2001-307219 discloses a system allowing a user to conduct commerce, such as placing an order, requesting a delivery, making a payment, and the like, with a virtual shop on a display screen.

Furthermore, Japanese Patent Laying-Open No. 2002-133234 discloses a reservation and order system which notifies a mobile communications instrument of a commodity provided by a shop having a website, and receives information of an order transmitted from the instrument and notifies the shop thereof so that the commodity, service and the like can be prepared before the client arrives at the shop.

Furthermore, Japanese Patent Laying-Open No. 2001-236397 discloses that in a commodity order system including a personal computer (PC) installed in a shop to monitor order data, orders are received from PC- and Internet-connectable mobile phones and the like for example via electronic mail and flyers are directly distributed to these terminals for example via electronic mail.

Furthermore, Japanese Patent Laying-Open No. 2002-259821 discloses that when a mobile communications device accesses a website having a commodity advertisement, a commodity advertisement adaptable to the device's positional information and contractor's attribute is selected and transmitted to the device.

Furthermore, Japanese Patent Laying-Open No. 2002-251396 discloses that a device displays a map, on which a still landscape image is displayed and thereon at a prescribed location a virtual shop conducting commerce on a network (the Internet) is arranged and at the virtual shop's location a hyper screen transition or the like is set to allow a jump from the map to the virtual shop's homepage.

Thus, conventionally, commerce utilizing a network not only has allowed a user to utilize the network to obtain information of a commodity but also order a commodity, receive distributed advertisement information, and the like, and furthermore allowed a virtual shop's information for example to be associated with an electronic map.

Thus utilizing a virtual shop can eliminate the necessity of a user actually visiting the shop and allows commerce to be conducted substantially as it would be done when the user actually visits the shop.

However, there has been a need for improvement in how clerks in virtual shops serve customers.

More specifically, conventionally if a user browsing a virtual shop has a question about a commodity of the shop and transmits the question via electronic mail, the user does not necessarily obtain a prompt response to the question, as would be provided when the user is actually in the shop. In this regard, some users have desired that the virtual shop have its clerk(s) better serve the users.

Furthermore if in an actual shop there is a customer considering whether to purchase a commodity the customer can be taken care of by a clerk actively explaining the commodity's advantage(s) and recommending the customer to purchase the commodity, whereas in conventional virtual shops such cannot be done. In this regard, some clerks have desired improvement in the response(s) that they can make in virtual shops.

### SUMMARY OF THE INVENTION

The present invention has been made to overcome such disadvantage and contemplates a virtual shop system capable of improving a response of a clerk of a virtual shop to a customer.

The present virtual shop system includes: a catalog display portion causing a customer terminal to display a commodity catalog via a network; a time information acquisition portion obtaining time information corresponding to information specifying a time elapsing while each customer terminal displays the catalog; and an information transmission portion transmitting the time information of each customer terminal to a shop terminal.

In accordance with the present invention a shop terminal of the virtual shop system is provided with each customer's time elapsing while a catalog is displayed for the customer.

This enables the shop terminal to attempt to serve each customer with reference to a time consumed while the customer is browsing the catalog. For example, a customer browsing the catalog for a long period of time is considered to be interested in a commodity(s) of the shop, and the shop's clerk can aggressively attend to the customer for example through realtime communication. By contrast, a customer who has just started to browse the catalog is not particularly attended to, allowed to continue to browse the catalog. The clerk can thus attend to customers, and in the virtual shop the clerk can attend to customers in accordance with their behaviors.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 diagrammatically shows a configuration of a virtual system of the present invention in one embodiment.

FIG. 2 diagrammatically shows a configuration of the server shown in FIG. 1.

FIG. 3 diagrammatically shows a configuration of a shop terminal shown in FIG. 1.

FIG. 4 diagrammatically shows a configuration of a customer terminal shown in FIG. 1.

FIG. 5 diagrammatically shows contents stored in memory of the server shown in FIG. 1.

FIG. 6 diagrammatically shows one example of the shop terminal information indicated in FIG. 5.

FIG. 7 diagrammatically shows one example of the customer terminal information indicated in FIG. 5.

FIGS. 8-10 are timing plots representing a process performed in the virtual shops system of the present embodiment by the server, the shop terminal, and the customer terminal.

FIGS. 11-14 show an example of displaying a screen at a monitor of the customer terminal shown in FIG. 1.

FIGS. 15-18 show an example of displaying a screen at a monitor of the shop terminal shown in FIG. 1.

FIG. 19 shows an example of displaying a screen as the monitor of the customer terminal shown in FIG. 1.

FIGS. 20-22 show an example of displaying a screen at the monitor of the shop terminal shown in FIG. 1.

### DESCRIPTION OF THE PREFERRED EMBODIMENTS

Hereinafter with reference to the drawings an embodiment of the present invention will be described.

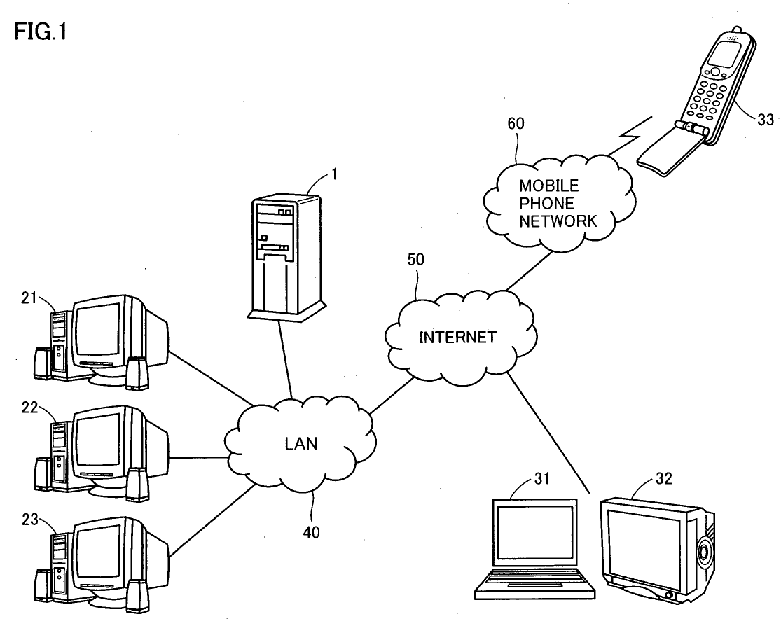

FIG. 1 shows a virtual shop system including a server 1 holding information or the like for displaying a homepage of a virtual shop, customer terminals 31-33 operated by a customer for example to browse the virtual shop's homepage, and shop terminals 21-23 operated by the virtual shop's clerk(s) for example to attend to a customer. As shown in FIG. 1, customer terminals 31-33 may be implemented by a PC, such as customer terminal 31, an Internet ready TV receiver, such as customer terminal 32, or an Internet ready mobile phone, such as customer terminal 33.

Shop terminals 21-23 and server 1 are connected on a local area network (LAN) 40, and LAN 40 and customer terminals 31-33 are connected on the Internet 50. More specifically, customer terminal 33 implemented by a mobile phone is connected on the Internet 50 and a mobile phone network 60 to LAN 40.

Note that the number configuration of server 1, those of shop terminals 21-23 and those of customer terminals 31-33 shown in FIG. 1 are merely one example and when the present invention is applied they may be replaced with those having similar functions or may have for example added thereto those having similar functions.

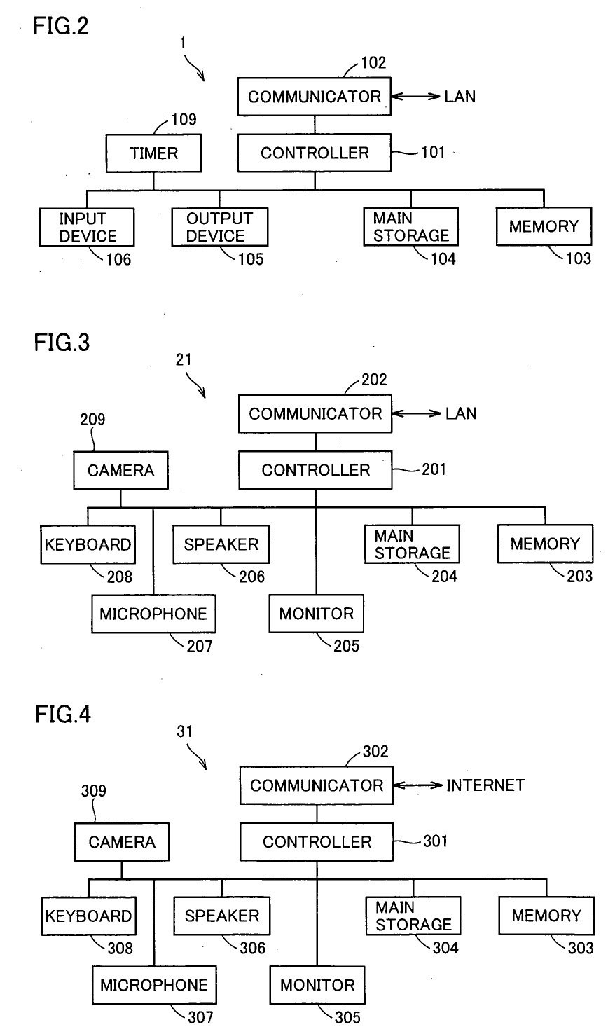

With reference to FIGS. 2-4, server 1, shop terminal 21, and customer terminal 31 are configured, as described hereinafter. Shop terminals 21-23 in application of the present invention are similarly configured and so are customer terminals 31-33 for the sake of illustration.

With reference to FIG. 2, server 1 includes a controller 101 generally controlling the operation of server 1, a communicator 102 performing an operation to communicate with a different device on LAN 40, a memory 103 storing a variety of information, a main memory 104 storing a program or the like executed by controller 101, an output device 105 implemented by a monitor, a speaker and/or other similar equipment outputting information, an input device 106 implemented by a keyboard and/or other similar equipment employed to input information, and a timer 109 counting time.

Furthermore, with reference to FIG. 3, shop terminal 21 includes a controller 201 generally controlling the operation of shop terminal 21, a communicator 202 performing an operation to communicate with a different device on LAN 40, a memory 203 storing a variety of information, a main memory 204 storing a program or the like executed by controller 201, a monitor 205, a speaker 206, a microphone 207 receiving an audio input, a keyboard 208, and a camera 209 used to obtain an image for example of a clerk who is a user of shop terminal 21.

Furthermore, with reference to FIG. 4, customer terminal 31 includes a controller 301 generally controlling the operation of customer terminal 31, a communicator 302 performing an operation to communicate with a different device on the Internet 50, a memory 303 storing a variety of information, a main memory 304 storing a program or the like executed by controller 301, a monitor 305, a speaker 306, a microphone 307 receiving an audio input, a keyboard 308, and a camera 309 used to obtain an image for example of a user of customer terminal 31.

Reference will now be made to FIG. 5 to describe content stored in memory 103 of server 1.

Memory 103 stores a variety of information including: system information corresponding to basic information required in operating the virtual shop system; information configuring a screen of the virtual shop (“virtual-shop screen configuration information”); shop terminal information corresponding to information of shop terminals 21-23; and customer information corresponding to information of customer terminals 31-33.

If server 1 controls a plurality of virtual shops, the system information includes information of where in memory 103 each virtual shop's virtual-shop screen configuration information is stored. The virtual-shop screen configuration information includes video data used to display a screen of the virtual shop at customer terminals 31-33, data of a sound output when the screen is displayed, and the like.

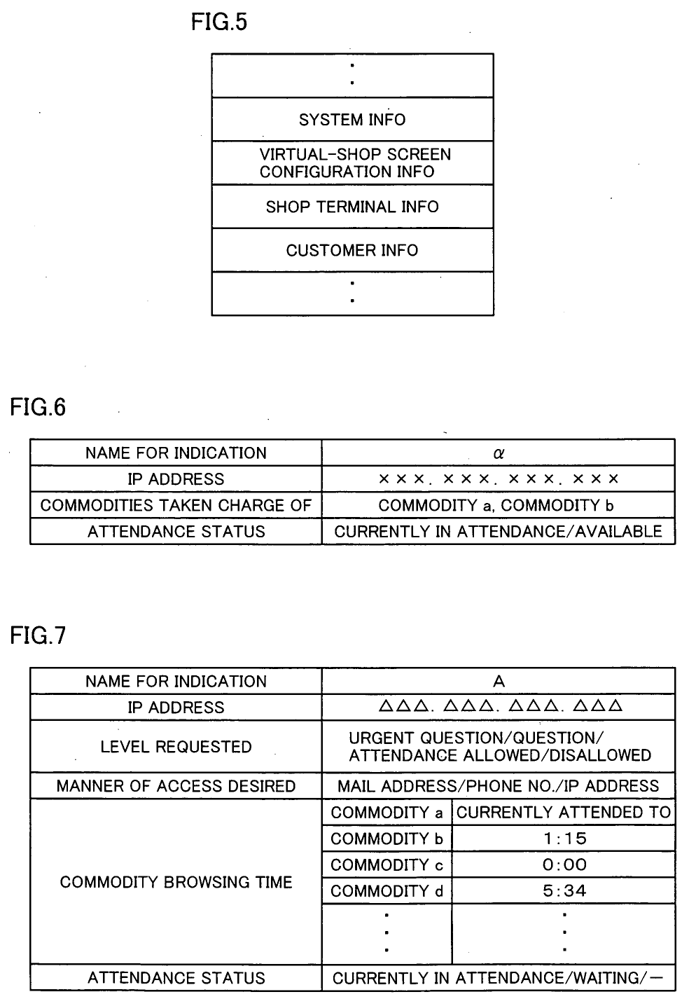

With reference to FIG. 6 one example of the shop terminal information will be described. Note that memory 103 stores the FIG. 6 information for each of all shop terminals connected on LAN 40 to server 1.

In the virtual shop system of the present embodiment each shop-terminal's monitor (monitor 205) displays information of all shop terminals connected to server 1, and the shop terminal information includes a name for indication employed to identify each shop terminal when its shop terminal information is displayed. In the present embodiment, shop terminals are named α, β, γ, δ . . . or the like and their information is displayed, although the name for indication is not limited thereto. Furthermore, the shop terminal information includes each shop terminal's IP address, commodities taken charge of by users operating shop terminals, respectively (hereinafter such user will be referred to as a virtual shop's clerk or simply a clerk), and each clerk's attendance status which in the present embodiment is indicated by “currently in attendance” or “available”.

With reference to FIG. 7 one example of the customer information will be described. Note that memory 103 stores the FIG. 7 information for each of all customer terminals connected on the Internet 50 to server 1.

In the virtual shop system of the present embodiment each shop terminal's monitor (monitor 205) displays information of all customer terminals connected to server 1, and the customer information includes a name for indication employed to identify each customer terminal when its customer terminal information is displayed. In the present embodiment customer terminals are named A, B, C, D . . . or the like and their information is displayed, although the name for indication is not limited thereto. Furthermore, the customer information includes: a level requested input from a customer terminal regarding attendance to a customer; a manner desired of access from a shop; a time having elapsed while the customer terminal browses a page showing each commodity of a virtual shop; and how the customer terminal is currently served.

Note that in the present embodiment the level requested is indicated by either “urgent question”, “question”, “attendance allowed” or “attendance disallowed”. The manner desired of access is indicated by either “mail address”, “telephone number” or “IP address”. The attendance status is indicated either “currently attended to”, “waiting” or “−”. For a customer attended to in realtime, as will be described later, the attendance status “currently attended to” is indicated. For a customer who wishes or does not mind realtime attendance, the attendance status “waiting” is indicated. For a customer who does not wish realtime attendance, the attendance status “−” is indicted.

FIG. 7 shows the customer information of a customer given a name for indication “A”. FIG. 7 shows that customer A browses a commodity b's page for 1 minute and 15 seconds, does not browse a commodity c's page, browses a commodity d's page for 5 minutes and 34 seconds, and is attended to for commodity a.

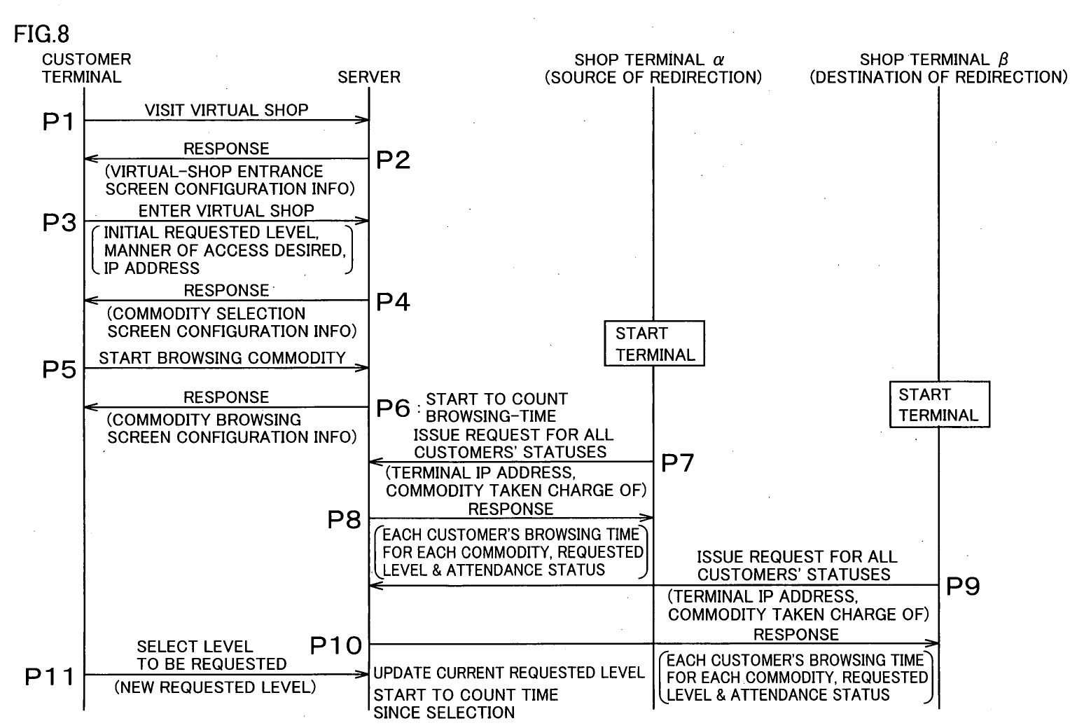

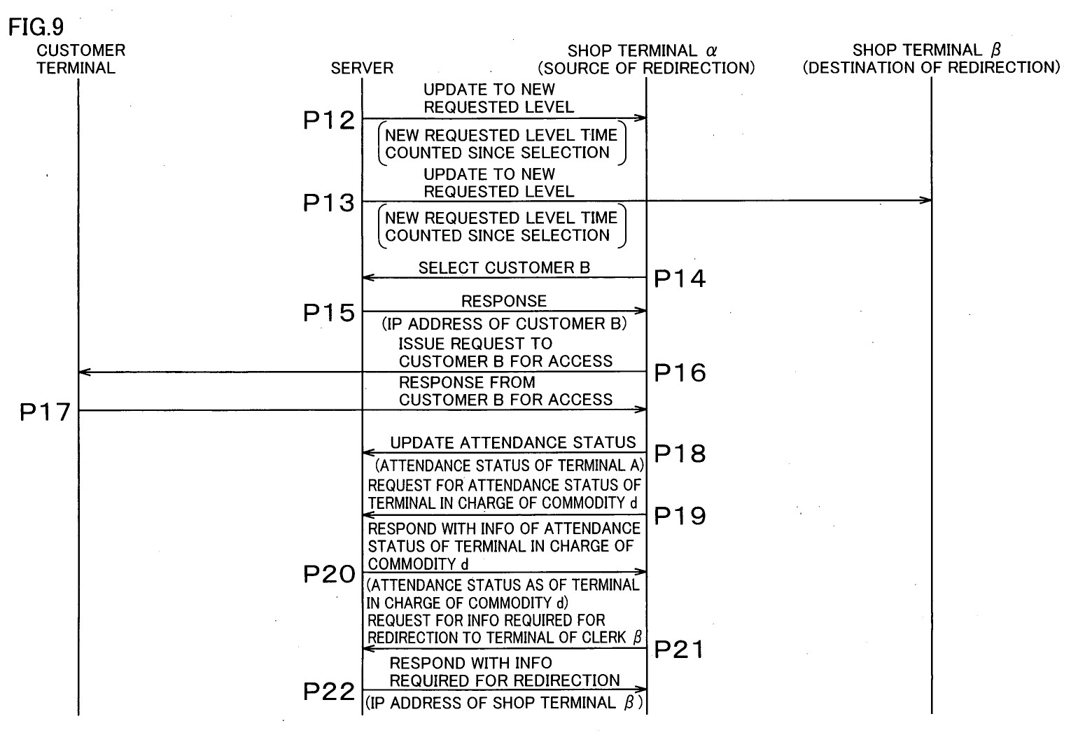

FIGS. 8-10 are timing plots representing a process performed in the virtual shop system of the present embodiment by server 1, shop terminals 21-23, and customer terminals 31-33. The timing plots start from FIG. 8 and successively continue to FIGS. 9 and then 10. Furthermore for the sake of convenience the timing plots are presented for a process effected by a single customer terminal (customer terminal 31 for the sake of convenience), a single server (server 1) and two shop terminals (shop terminals 21 and 22 for the sake of convenience). Furthermore in the timing plots shop terminal 21 is indicated as a shop terminal given a name for indication “α” (or a shop terminal α) and shop terminal 22 is indicated as a shop terminal given a name for indication “β” (or a shop terminal β). Furthermore in FIGS. 8-10 information is communicated as indicated by arrows. Note that the characters on each arrow specifically describe an operation, and the bracketed characters under each arrow specifically describe information (data) communicated in the operation.

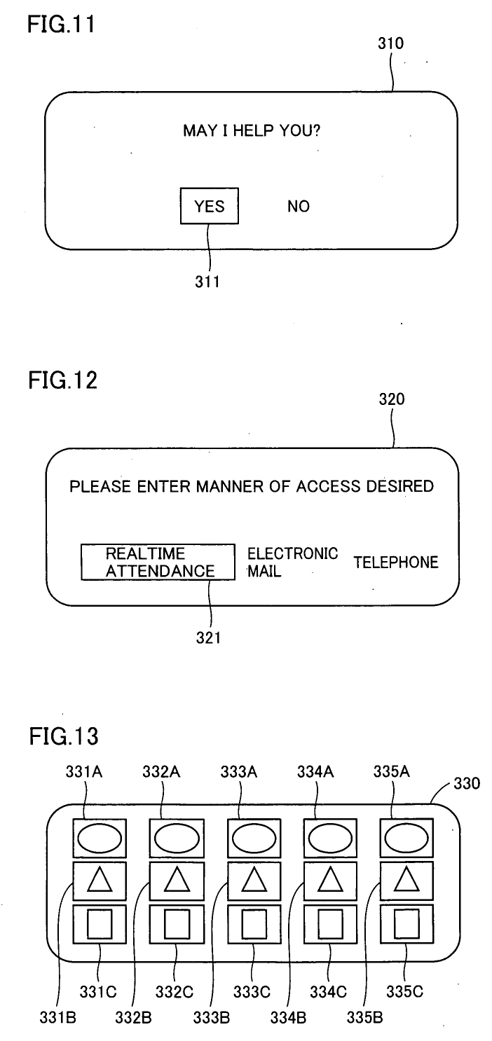

FIGS. 11-14 and 19 show an example of displaying a screen at monitor 305 of shop terminal 31, and FIGS. 15-18 and 20-22 show an example of displaying a screen at monitor 205 of shop terminal 21, 22.

Hereinafter with reference to FIGS. 8-22, as appropriate, one example of communicating information between devices in the virtual shop system of the present embodiment, will be described.

Initially, with reference to FIG. 8, customer terminal 31 initially accesses server 1, as indicated by arrow P1, to visit a virtual shop. In response, as indicated by arrow P2, server 1 transmits to customer terminal 31 the information of the virtual-shop screen configuration information that configures a screen of an entrance (or top page) of the virtual shop, and the customer terminal 31 monitor 305 displays a screen 310 shown in FIG. 11.

Screen 310 displays a message “May I help you?”, and trains of characters “Yes” and “No” as candidates for the customer's response. Screen 310 also displays a cursor 311 used to select “Yes” or “No” at customer terminal 31.

At customer terminal 31 the screen 310 indication is responded to by an appropriate operation and on the screen “Yes” or “No” is selected. The customer has thus entered the virtual shop, as indicated in FIG. 8 by arrow P3, and from customer terminal 31 to server 1 which of “Yes” or “No” has been selected is transmitted as an “initial requested level”.

An initial requested level refers to an initial one of levels requested transmitted from customer terminal 31 (see FIG. 7) and corresponds to the “Yes” and “No” displayed on screen 310. Note that if “Yes” is selected server 1 stores a requested level “attendance allowed” as an initial requested level, and if “No” is selected then server 1 stores a requested level “attendance disallowed” as an initial requested level. In the present embodiment, information transmitted from customer terminal 31 that specifies a requested level including an initial requested level, configures information on how a customer wishes to be served.

If at customer terminal 31 the screen 310 indication is responded to by selecting “Yes” then the customer terminal 31 monitor 305 further displays a screen 320 shown in FIG. 12. Screen 320 displays a message “Please input a manner of access desired”, and trains of characters “realtime attendance”, “electronic mail” and “telephone” and a cursor 321 overlapping one of the trains of characters.

At customer terminal 31 cursor 321 can be used to select any of “realtime attendance”, “electronic mail” and “telephone”, and the selected content is transmitted together with an initial requested level to server 1 and stored as a manner of access desired. If “realtime attendance” is selected then from shop terminal 21 (or 22) to customer terminal 31 an attendance in the form of conversation through realtime communication, such as electronic chat on the Internet 50, is proposed. If “electronic mail” is selected then from shop terminal 21 (or 22) to customer terminal 31 electronic mail is transmitted as attendance. If “telephone” is selected then from the shop to the customer a telephone call is made on a public telephone line. Note that if “electronic mail” is selected, customer terminal 31 is requested to enter an electronic mail address, which is stored to server 1 together with the manner of access desired, and that if “telephone” is selected, then customer terminal 31 is requested to enter a telephone number which is in turns stored to server 1 together with the manner of access desired.

When customer terminal 31 enters the virtual shop, the server 1 controller 101 obtains an IP address corresponding to information that specifies customer terminal 31 on the Internet 50 (“terminal specifying information”) and stores it to memory 103 as an “IP address” included in the customer information.

When customer terminal 31 enters the virtual shop, then as a response server 1 transmits to customer terminal 31, as indicated by arrow P4, the information in the virtual-shop screen configuration information that configures a screen for selecting a commodity of the virtual shop, and the customer terminal 31 monitor 305 displays a screen 330 shown in FIG. 13.

Screen 330 displays 15 commodities in thumbnail images 331A-331C, 332A-332C, 333A-333C, 334A-334C, and 335A-335C. At customer terminal 31 the customer selects one of the 15 commodities that interests him/her. Note that screen 330 displaying 15 commodities in thumbnail images for selection is merely one example, and how many commodities are displayed and how they are displayed may be varied.

Customer terminal 31 is operated to select one commodity and in response, as indicated by arrow P5, information of which commodity has been selected is transmitted to server 1.

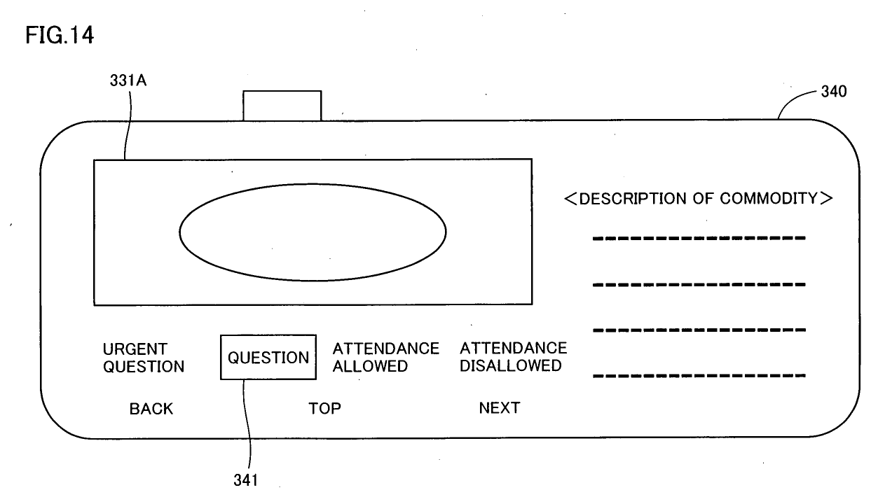

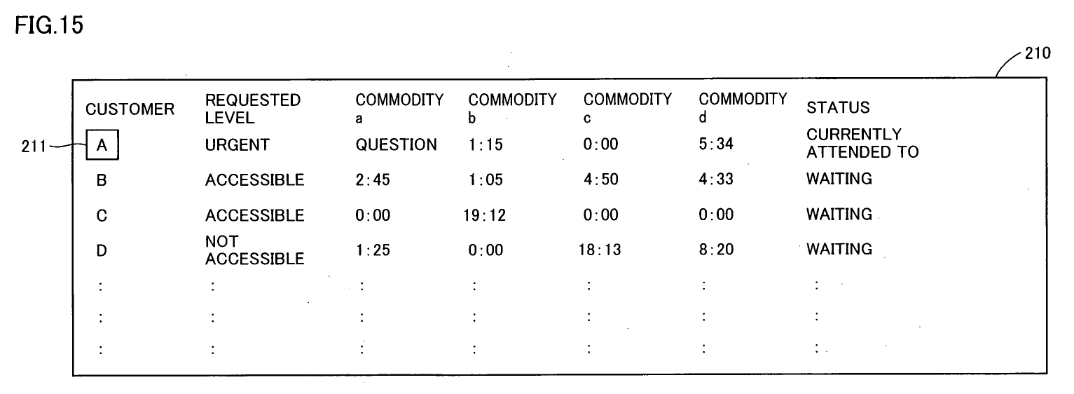

Based thereon, server 1 transmits to customer terminal 31, as indicated by arrow P6, the information in the virtual-shop screen configuration information that is used to browse a screen associated with the selected commodity (“commodity browsing screen configuration information”). The customer terminal 31 monitor 305 displays a screen 304 shown in FIG. 14, while server 1 starts to count a time elapsing while the screen of the commodity is being browsed at customer terminal 31.

On the other hand, shop terminals 21, 22 request server 1, as indicated by arrows P7 and P9, respectively, to provide information of all customer terminals' statuses including that of customer terminal 31. In response, server 1 transmits to shop terminals 21, 22, as indicated by arrows P8 and P10, respectively, the information of the customer information stored in memory 103 that indicates a time consumed by each customer to browse each commodity; a level requested by the customer; and how the customer is served. Thus the shop terminals 21, 22 respective monitors 205 display a screen 210 shown in FIG. 15. Note that the request indicated by arrows P7 and P9 is issued for example periodically at predetermined time intervals.

With reference to FIG. 14, screen 340 displays image 331A, enlarged as compared with that displayed on screen 330 (see FIG. 13). Furthermore, screen 340 has a portion adjacent to a right side of image 331A presenting a caption of a commodity shown in image 331A and also displays under image 331A the trains of characters “urgent question”, “question”, “attendance allowed” and “attendance disallowed” as levels requested and a cursor 331 used to select one of these levels. Furthermore, screen 340 also displays under these trains of characters a button “back” causing monitor 305 to display an immediately previous screen, a button “top” causing monitor 305 to display the virtual shop's top page, and a button “next” causing monitor 305 to display a subsequent screen.

With reference to FIG. 15, screen 210 displays for each customer a name for indication (see FIG. 7), a requested level, a time consumed to browse each commodity, and how the customer is served. Note that screen 210 also displays a cursor 211 used at each shop terminal 21, 22 to select a name for indication of a customer terminal to be served.

If at customer terminal 31 with screen 340 displayed a level that is requested is selected, then, as indicated by arrow P11, that the level has been selected is transmitted to server 1. In response, server 1 has a requested level in the customer information updated by the transmitted requested level, and as indicated by arrows P12, P13 (see FIG. 9), transmits the received requested level to shop terminals 21, 22 together with information identifying customer terminal 31. Note that if the selected requested level is “urgent question” or “question”, server 1 starts counting a period of time elapsing since the level was selected, i.e., while the customer is waiting after he/she has issued a request that he/she has a question, and as has been indicated by arrows P12, P13, together with the received requested level the period of time elapsing since the level was selected, (i.e., that counted since the selection) is also transmitted to shop terminals 21, 22.

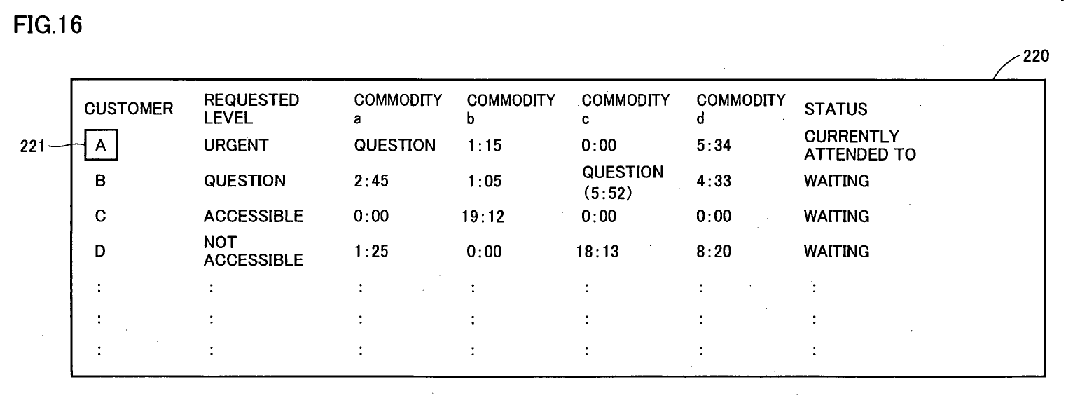

With reference to FIG. 16, if with screen 210 (see FIG. 15) displayed a customer having a name for indication “B” selects the level “question” the shop terminals 21, 22 monitors 205 display a screen 220.

With reference to FIGS. 15 and 16, when screens 210 and 220 are compared, the latter displays for customer B a requested level changed from “accessible” to “question”, the train of characters “question” at a section indicating a time consumed to browse commodity c, together with a time elapsing since the customer selected the requested level “question” (i.e., a time counted since the selection (in FIG. 16, a temporal period of 5 minutes and 52 seconds is indicated as one example)). Note that screen 220 also displays a cursor 221 identical in application to cursor 211 or used to select a customer. Note that “accessible” indicates that the level “attendance allowed” is selected and that the customer has selected “realtime attendance” as a manner of access desired. Note that “urgent” indicates that the level “urgent question” has been selected and that the customer has selected “realtime attendance” as a manner of access desired.

When at shop terminal 21 with monitor 250 displaying screen 220 cursor 221 is operated to select customer B to attend to customer B in realtime, as indicated by arrow P14, server 1 responsively transmits to shop terminal 21 the IP address included in the customer information that corresponds to customer terminal 31 operated by customer B, as indicated by arrow P15.

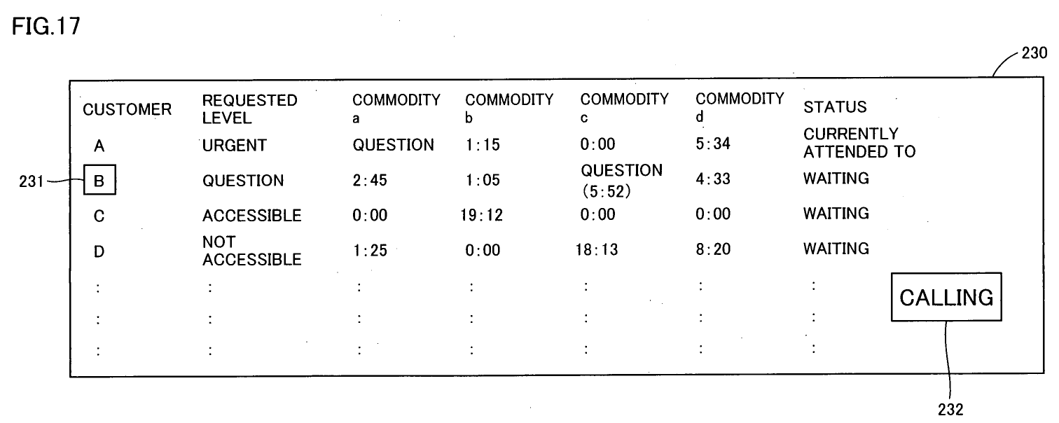

Shop terminal 21 receives the IP address of customer terminal 31 of customer B and in response, as indicated by arrow P16, transmits to customer terminal 31 corresponding to customer B the information requesting a realtime access such as electronic chart. In doing so, the shop terminal 21 monitor 205 displays a screen 230, as shown in FIG. 17. Screen 230 displays each customer's requested level, browsing time, attendance status and the like as well as a cursor 231 placed on the name for indication “B” corresponding to a customer who is a counterpart transmitting a request for access, and an image 232 displaying a train of characters (in this scenario, “calling”) indicating that customer B is being called.

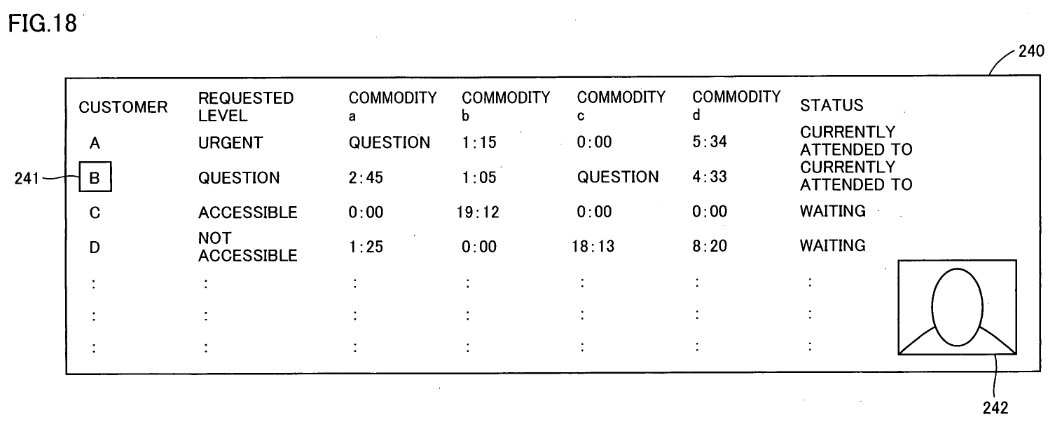

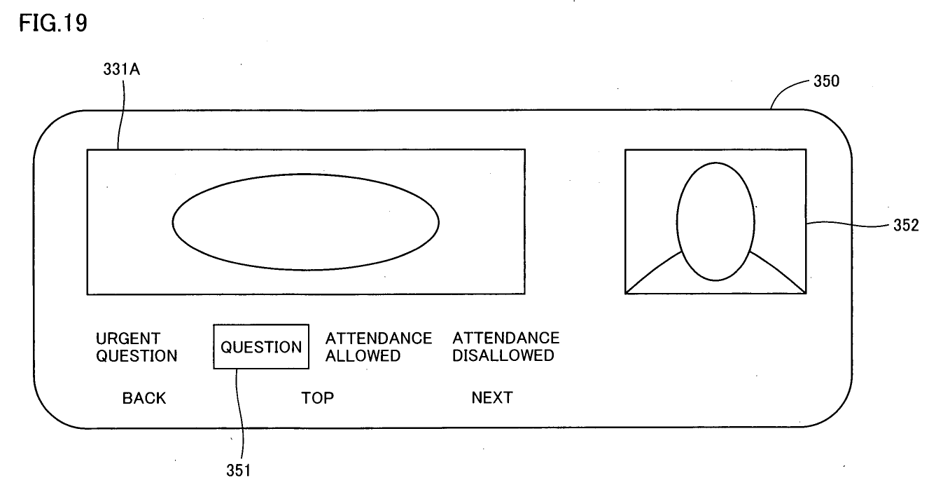

Customer terminal 31 responds to the request from shop terminal 21 for access by making a response to shop terminal 21, as indicated by arrow P17, and customer terminal 31 and shop terminal 21 start realtime communication. The shop terminal 21 monitor 205 displays a screen 240 as shown in FIG. 18 while the customer terminal 31 monitor 305 displays a screen 350 as shown in FIG. 19.

Screen 240 displays each customer's requested level, browsing time, attendance status and the like as well as a cursor 241 placed on the name for indication of customer B communicating with the shop, and an image 242 representing an image obtained at customer terminal 31 via camera 309. Note that while screen 240 is displayed by the shop terminal 21 monitor 205, an audio input to customer terminal 31 via microphone 307 is output from shop terminal 21 via speaker 206.

Screen 350 displays image 331A associated with a commodity for which the customer currently has a question, as well as a cursor 351 indicating a level currently requested via customer terminal 31, and an image 352 representing an image obtained via camera 209 of shop terminal 21 communicating with the customer. Note that while screen 350 is displayed by monitor 305 of customer terminal 31, an audio input to shop terminal 21 via microphone 207 is output from customer terminal 31 via speaker 306.

Shop terminal 21 having received a response transmits to server 1, as indicated by arrow P18, the information included in the customer information which is associated with updating customer B's attendance status to “currently attended to”. Server 1 updates the information accordingly.

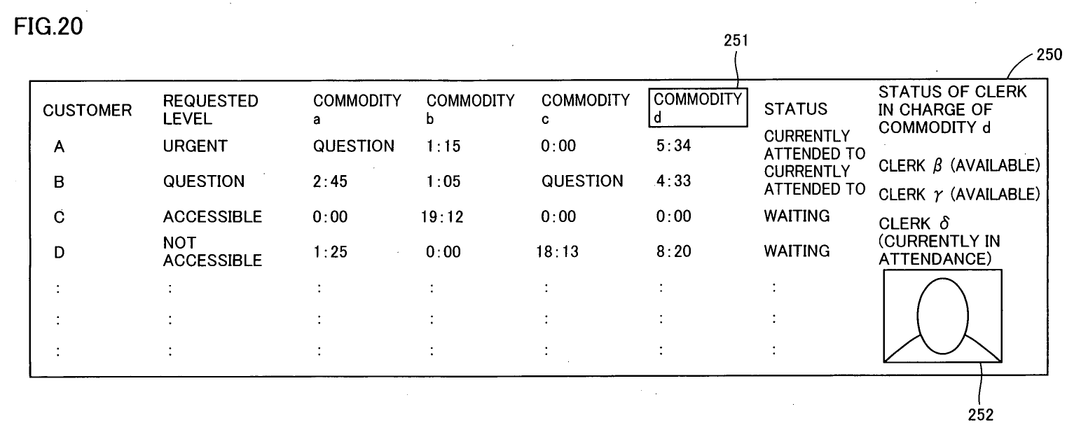

For the sake of illustration, if a customer operating customer terminal 31 to have a realtime communication asking a question on commodity c to a clerk operating shop terminal 21 now wishes to ask a question on commodity d to a clerk who is in charge of commodity d, and the clerk operating shop terminal 21 has received such a request, then, as indicated by arrow P19, the clerk requests server 1 to transmit the attendance status of such a shop terminal among those connected to server 1 that the shop terminal information includes commodity d as a commodity taken charge of (see FIG. 6). In response, server 1 searches through the shop terminal information to select such a shop terminal's attendance status and transmits it to shop terminal 21, as indicated by arrow P21. Thus the shop terminal 21 monitor 205 displays a screen 250 as shown in FIG. 20.

Screen 250 displays each customer's requested level, browsing time, attendance status and the like as well as an image 252 representing an image obtained at customer terminal 31 via camera 309, a cursor 251 placed on a train of characters indicating the current subject or commodity d, and a title “status of clerk in charge of commodity d” and thereunder an attendance status (“available” or currently in attendance”) for each of clerks β, γ, δ, who are in charge of commodity d.

From the screen 205 indication, at shop terminal 21 a process is effected to switch attendance to clerk β currently having the attendance status “available” for the sake of illustration. To do so, shop terminal 21 requests server 1, as indicated by arrow P21, to provide information required for redirection to clerk β's terminal. More specifically, shop terminal 21 requests server 1 to transmit an IP address of a shop terminal β (hereinafter shop terminal 22 for the sake of illustration) operated by clerk β. In response, as indicated by arrow P22, server 1 transmits the information or the IP address of shop terminal β (shop terminal 22) to shop terminal 21.

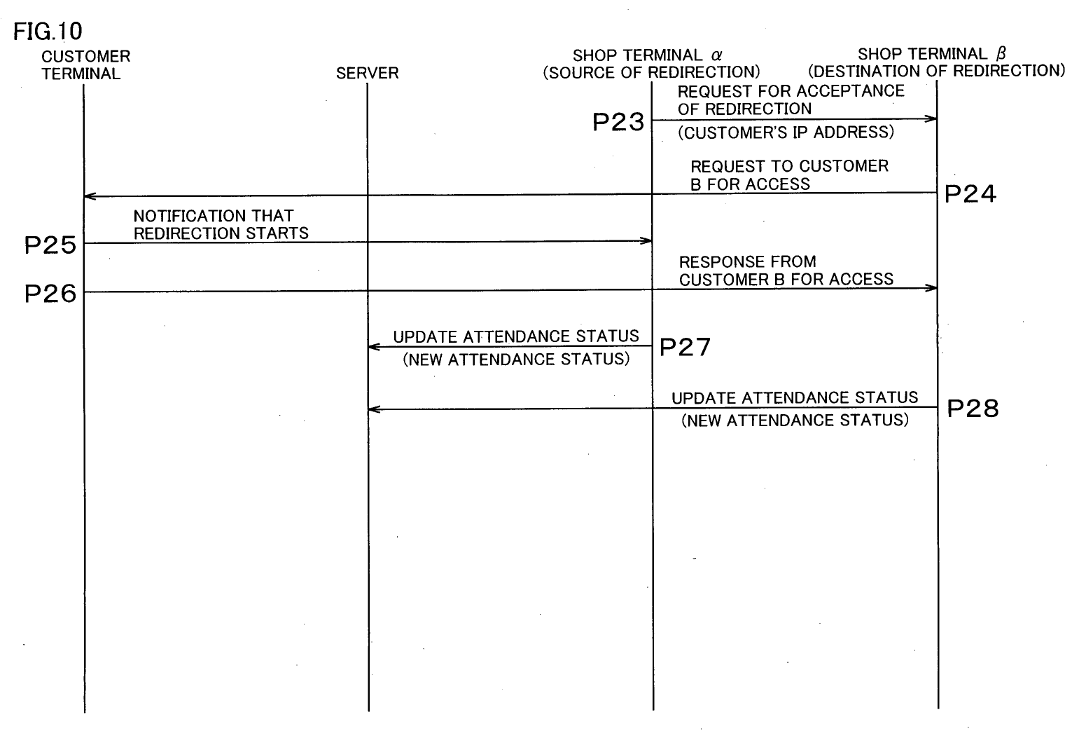

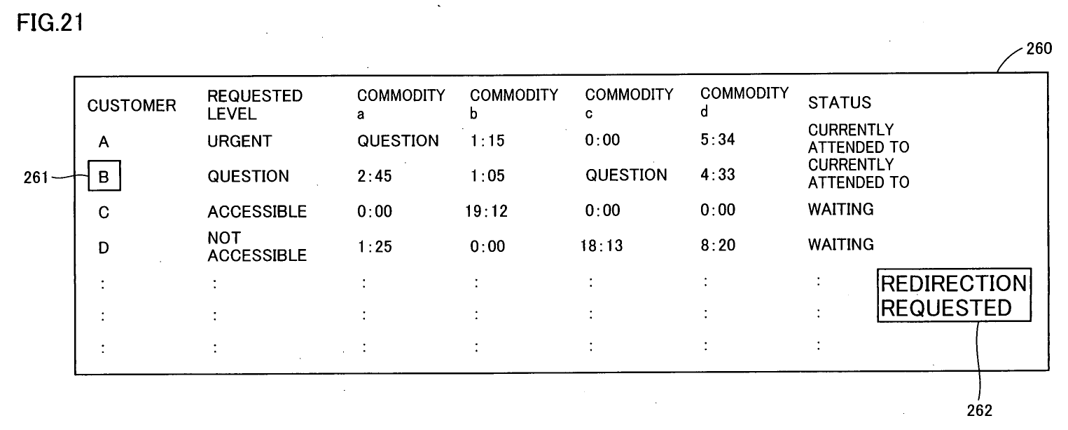

Shop terminal 21 having received the shop terminal 22 IP address requests shop terminal 22, as indicated in FIG. 10 by arrow P23, to accept a redirection as if a telephone call were redirected. In doing so, shop terminal 21 transmits to shop terminal 22 the IP address of customer terminal 31, a terminal that shop terminal 21 has been communicating in realtime. Shop terminal 22 receives the request and its monitor 205 displays a screen 260 as shown in FIG. 21.

Screen 260 displays each customer's requested level, browsing time, attendance status and the like as well as a cursor 261 placed on the name for indication “B” corresponding to a customer currently communicating with the shop and to be redirected, and an image 262 including a train of characters indicating that the redirection is requested (“redirection requested”).

Shop terminal 22 accepts the redirection and obtains the IP address of customer terminal 31, and as indicated by arrow P24, transmits information requesting a realtime access, such as electronic chart, to customer terminal 31 corresponding to customer B.

In response to the request from shop terminal 22 for access, customer terminal 31 notifies shop terminal α (shop terminal 21) that the redirection starts, as indicated by arrow P25, and subsequently responds to shop terminal β (shop terminal 22), as indicated by arrow P26. Customer terminal 31 and shop terminal 22 thus start realtime communication.

Shop terminals 21 and 22 thus have their respective attendance statuses changed, and accordingly transmit to server 1 information indicating that their attendance statuses have changed (arrows P27, P28). Server 1 updates the shop terminal information (see FIG. 6) to update the shop terminal 21 attendance status from “currently in attendance” to “available” and the shop terminal 22 attendance status from “available” to “currently in attendance”.

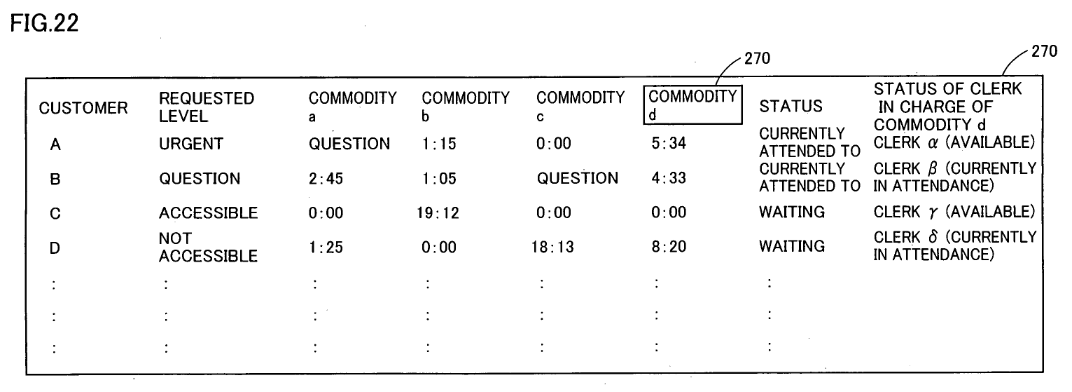

If with shop terminal 22 communicating with customer terminal 31 another shop terminal requests server 1 to provide an attendance status of a terminal in charge of commodity d, as indicated by arrow P19, the latter shop terminal's monitor 205 displays a screen 270 shown in FIG. 22.

Screen 270 displays each customer's requested level, browsing time, attendance status and the like as well as a cursor 271 placed on a train of characters indicating the current subject or commodity d, and a title “status of clerk in charge of commodity d” and thereunder an attendance status (“available” or “currently in attendance”) for each of clerks β, γ, δ who are in charge of commodity d. When screen 270 is compared with screen 250 (see FIG. 20), the former screen displays that clerk β has an attendance status changed from “available” to “currently in attendance” and that a customer with the name for indication “B” is asking a “question” on commodity c. Displaying that a question is asked means that such a waiting time as screen 220 is not displayed.

Thus, in the present embodiment as described above, memory 103 holding information configuring screens 330, 340, 350 associated with a commodity, as shown in FIGS. 13, 14 and 19, and controller 101 and communicator 102 transmitting the information to customer terminal 31 configure a catalog display portion. Furthermore, controller 101 obtaining a time, as counted by timer 109, elapsing while each commodity is browsed, and stored in memory 103, as shown in FIG. 7, and displayed at shop terminals 21, 22 by monitor 205, as shown for example in FIG. 15, configures a portion obtaining temporal information.

In the above described embodiment, server 1 configures the virtual shop system. It should be noted, however, that the present virtual shop system is not limited to a system configured of a single apparatus, and may be configured of a plurality of series-connected or networked apparatuses.

Although the present invention has been described and illustrated in detail, it is clearly understood that the same is by way of illustration and example only and is not to be taken by way of limitation, the spirit and scope of the present invention being limited only by the terms of the appended claims.

1. A virtual shop system comprising:
a catalog display portion causing a customer terminal to display a commodity catalog via a network;
a time information acquisition portion obtaining time information corresponding to information specifying a time elapsing while each said customer terminal displays said catalog; and
an information transmission portion transmitting said time information of each said customer terminal to a shop terminal.

2. The virtual shop system of claim 1, wherein:
said catalog display portion displays a catalog of a different page for each commodity; and
said time information acquisition portion obtains for each page of said catalog said time information corresponding to information specifying a time displayed at each said customer terminal.

3. The virtual shop system of claim 1, further comprising an attendance information reception portion receiving desired attendance information corresponding to information transmitted from each said customer terminal and associated with a manner of attendance desired by said customer terminal's user, wherein said information transmission portion transmits said desired attendance information of each said customer terminal to said shop terminal.

4. The virtual shop system of claim 3, wherein said attendance information reception portion presents a plurality of candidates for said desired attendance information to said customer terminal, and receives said desired attendance information by receiving information selecting one of said plurality of candidates.

5. The virtual shop system of claim 3, further comprising an attendance information storage portion storing said desired attendance information of each said customer terminal received by said attendance information reception portion, wherein:
said attendance information reception portion receives said desired attendance information transmitted from each said customer terminal more than once while said customer terminal displays said catalog; and
said attendance information storage portion updates said desired attendance information that has been stored to said desired attendance information latest received by said attendance information reception portion.

6. The virtual shop system of claim 3, wherein said attendance information reception portion receives as said desired attendance information information including a manner of access from said shop terminal to said customer terminal.

7. The virtual shop system of claim 6, wherein said manner of access includes realtime communication.

8. The virtual shop system of claim 1, further comprising a terminal specifying information acquisition portion obtaining on a network terminal specifying information corresponding to information specifying each said customer terminal, wherein said information transmission portion transmits said terminal specifying information of each said customer terminal to said shop terminal.

9. The virtual shop system of claim 8, wherein:
said catalog display portion distributes information causing said customer terminal to display said catalog via the Internet; and
said terminal specifying information acquisition portion obtains as said terminal specifying information each said customer terminal's Internet protocol (IP) address, telephone number or electronic mail address.

10. The virtual shop system of claim 8, wherein said information transmission portion includes a request reception portion receiving information associated with a request issued from one said customer terminal to one said shop terminal, and when said request reception portion receives said information associated with said request from one said customer terminal, said information transmission portion transmits said terminal specifying information of said one customer terminal to said one shop terminal.

11. The virtual shop system of claim 1, further comprising:
an attendance information reception portion receiving desired attendance information corresponding to information of a manner of attendance desired by said customer terminal's user; and
a desired-attendance information transmission portion operative in response to said attendance information reception portion having received said desired attendance information to transmit to said shop terminal information specifying said customer terminal having transmitted said desired attendance information and information indicating that said customer terminal has transmitted said desired attendance information.

12. The virtual shop system of claim 11, further comprising a timer counting a time since said desired-attendance information reception portion received said desired attendance information from each said customer terminal, wherein said desired-attendance information transmission portion transmits a time counted by said timer to said shop terminal together with information specifying a corresponding said customer terminal.

13. A method of controlling a virtual shop system, comprising the steps of:
causing a customer terminal to display a catalog of a commodity via a network;
obtaining time information corresponding to information specifying a time elapsing while each said customer terminal is displaying said catalog; and
transmitting said time information of each said customer terminal to a shop terminal.
